(19) United States
(12) Patent Application Publication
(10) Pub. No.: US 2026/0199054 A1
(43) Pub. Date: Jul. 16, 2026

(54) Dental Drill

(71) Applicant: Platinum Point LLC

(72) Inventor: Matthew Ray Gonzales, Statesville, NC (US)

(73) Assignee: Platinum Point LLC, Raleigh, NC (US)

(21) Appl. No.: 19/022,590

(22) Filed: Jan. 15, 2025

(51) Int. Cl. A61C 1/06; A61C 3/02; A61C 17/02

(52) U.S. Cl. CPC A61C 1/06; A61C 3/02; A61C 17/0202

(57) ABSTRACT

A high-speed dental drill having a low noise level is disclosed. The dental drill includes an elongated body, and a head portion connected at one end of the elongated body. The head portion includes a motor rotating about an axis. The motor comprises a magnetic turbine having coil wraps. The head portion includes a bur inserted into a chuck. The head portion includes a spindle connected to the chuck. The head portion includes connectors. The connectors electrically connect to the magnetic turbine and provide a magnetic field to the magnetic turbine causing the chuck, the spindle and the bur to rotate.

### CROSS-REFERENCE TO RELATED APPLICATION

None.

### FIELD OF THE DISCLOSURE

The present invention relates to a dental drill, and more specifically, to a dental drill having a low noise output.

### BACKGROUND OF THE INVENTION

It is known that a dental drill or a handpiece is used to perform a variety of dental procedures, including, but not limited to, removing decay, polishing fillings, performing cosmetic dentistry, and altering prostheses. The dental drills include electric and turbine powered drills. Typical turbine powered dental drill uses compressed air to rotate a drill head at a high speed. The high speed causes high pitch frequency. The high pitch frequency causes anxiety, fear and trauma for many individuals undergoing dental procedures.

Several dental drills have been disclosed in the past. One such example is disclosed in a United States Publication No. 20080118890, entitled “Electric Dental Handpiece and Control System” (“the '890 Publication”). The '890 Publication discloses an electric dental handpiece including a head engaging a handle and configured to rotatably support a tool. The handle includes a lower handle portion and an upper handle portion with the lower handle portion engaging the head and the upper handle portion having an attachment area configured for attachment to a power supply. An electric motor is positioned with a majority thereof within the lower handle portion and is configured to rotate the tool. Additionally, a method of operating a dental drilling system connected with one of a plurality of handpieces.

Another example is disclosed in a U.S. Pat. No. 5,800,172, entitled “Dental Turbine Hand Piece with Light and Rotary Head” (“the '172 Patent”). The '172 Patent discloses a dental turbine hand piece having a body, a turbine rotatable in the body about an axis, a light source arranged on the body, and means for current supply to the light source, a magnetic element formed on one of the turbine and the body, and a winding provided on the other of the turbine element in the body, so that during rotation of the turbine and in the body and interaction between the magnetic member and the winding and electric current is generated which is supplied to the light source.

Another example is disclosed in a United States Publication No. 20130052606, entitled “Closed Loop Speed Control for a Pneumatic Dental Handpiece” (“the '606 Publication”). The '606 Publication discloses a detection system for remotely determining the speed of a rotating tool tip in a pneumatic dental handpiece. A means for detecting the speed of the rotating tool tip monitors a periodic mechanical function at the pneumatic hose connected to the handpiece. The monitored periodic mechanical function serves to provide feedback that is used to control the speed of the rotating tool tip. The means for detecting the speed of the rotating tool detects a mechanical function of the rotating tool tip, which in transmitted to a controller. The controller in turn regulates the operation of an air supply valve in response to the detected mechanical function. The valve regulates the flow of air to the handpiece. By continuously adjusting the flow of air through the valve into the pneumatic hose, the speed of the rotating tool is maintained at the desired cutting speed.

Yet another example is disclosed in a U.S. Pat. No. 10,058,398, entitled “Turbine Dental Drill Mechanism and Turbine Head with Same Mounted Therein” (“the '398 Patent”). The '398 Patent discloses a turbine dental drill mechanism, which includes a turbine and a turbine shaft. A balancing chamber is provided on the mechanism and includes an automatic balancing component provided therein. The automatic balancing component is a metal ball, sand grains or a flexible body. The metal ball in the balancing chamber can enhance the balance. The sand grains in the balancing chamber can reduce noise while also enhancing balance. The flexible body in the balancing chamber can eliminate noise and provide weight adjustment, thereby achieving automatic balancing.

The above discussed dental drills use air compression and air compressors with hoses and electric hand pieces, but no magnetic frequencies. Further, the above discussed dental drills are loud, generate a lot of heat, and are expensive.

Still, there remains a continuing need for improved dental drills.

### BRIEF SUMMARY OF THE PRESENT INVENTION

The present invention includes embodiments for a dental drill having an advanced magnetic field turbine within a dental drill, which eradicates (or substantially diminishes) emission of high pitch frequencies and heat, thereby reducing anxiety in patients.

The present invention provides a high-speed dental drill having a low noise level is disclosed. The dental drill includes an elongated body, and a head portion connected at one end of the elongated body. The head portion includes a motor rotating about an axis. The motor includes a magnetic turbine having coil wraps. The head portion includes a bur inserted into a chuck. The head portion includes a spindle connected to the chuck. The head portion includes connectors. The connectors electrically connect to the magnetic turbine and provide a magnetic field to the magnetic turbine causing the chuck, the spindle and the bur to rotate.

In one aspect of the present invention, the connectors include a positive connector and a negative connector to power the magnetic turbine. The connectors include a wire insulator. The wire insulator facilitates in flowing electricity into and out of the magnetic turbine. The coil wraps connect to the connectors for enabling the rotation of the magnetic field in the magnetic turbine. In other words, the magnetic turbine (or magnetic field turbine) contains a plurality of magnetic charges (rotation). The magnetic turbine is built based on a high or low speed dental drill and/or the amount of coil wraps depending on the wattage required. The positive connector and the negative connector are made of iron cores. The positive connector and the negative connector connect to the coil wraps and enable the rotation of the magnetic field. Further, the positive connector and the negative connector allow for electricity to flow through the coil and into the dental drill. The magnetic turbine reduces the bur from overheating and diminishes high pitch frequency levels in the dental practices.

In another aspect of the present invention, the motor includes a casing. The casing protects the magnetic turbine from debris and water damage. The internal casing acts as a housing unit for the electromagnetic direct-current (DC) turbine. The casing acts as a retainer for the magnetic turbine. The casing is used to insert or remove the magnetic turbine from the head.

In another aspect of the present invention, the magnetic turbine includes bearings. The bearings are made of rubber material. The rubber bearings allow for great torque and weight control. The rubber bearings reduce the noise while getting rid of ceramic ball bearings.

In one advantageous feature of the present invention, the dental drill incorporates the magnetic turbine (electromagnetic turbine) and eliminates the need for air driven dental drills or handpieces. Further, the use of a magnetic turbine eliminates the use of an impeller and ceramic ball bearings, which are the main parts that create the screeching sound of standard dental drills.

Features and advantages of the subject matter hereof will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

With the above and other related objects in view, the subject matter consists in the details of construction and combination of parts as will be more fully understood from the following description, when read in conjunction with the accompanying drawings in which:

FIG. 1 illustrates an environment in which a dental drill is used, in accordance with one embodiment of the present invention;

FIG. 2 illustrates a perspective view of the dental drill, in accordance with one embodiment of the present invention;

FIG. 3 illustrates a cross-sectional view of a body and a head of the dental drill, in accordance with one embodiment of the present invention;

FIG. 4 and FIG. 5 illustrate a cross-sectional view, and an exploded view, respectively of the head, in accordance with one embodiment of the present invention;

FIG. 6 illustrates a side view of a chuck inside the head, in accordance with one embodiment of the present invention;

FIG. 7 illustrates a motor surrounding a magnetic turbine, in accordance with one embodiment of the present invention;

FIG. 8A, FIG. 8B, FIG. 8C and FIG. 8D illustrate a front bottom perspective view, a rear bottom perspective view, a side view and a front view, respectively of the head, in accordance with one embodiment of the present invention;

FIG. 9 illustrates an environment of a dental drill used with solar panels, in accordance with one embodiment of the present invention; and

FIG. 10 illustrates an environment of a dental drill operated using a foot penal, in accordance with one embodiment of the present invention.

### DETAILED DESCRIPTION OF EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein. All patents, patent applications and non-patent literature cited through this application are hereby incorporated by reference in their entireties.

A key component of the present embodiments is the DC variable magnetic turbine, and the main rotation. In a preferred embodiment there are coil wrappings around a plurality of iron cores. In one example, the coil wrappings include two or more three sets of iron cores.

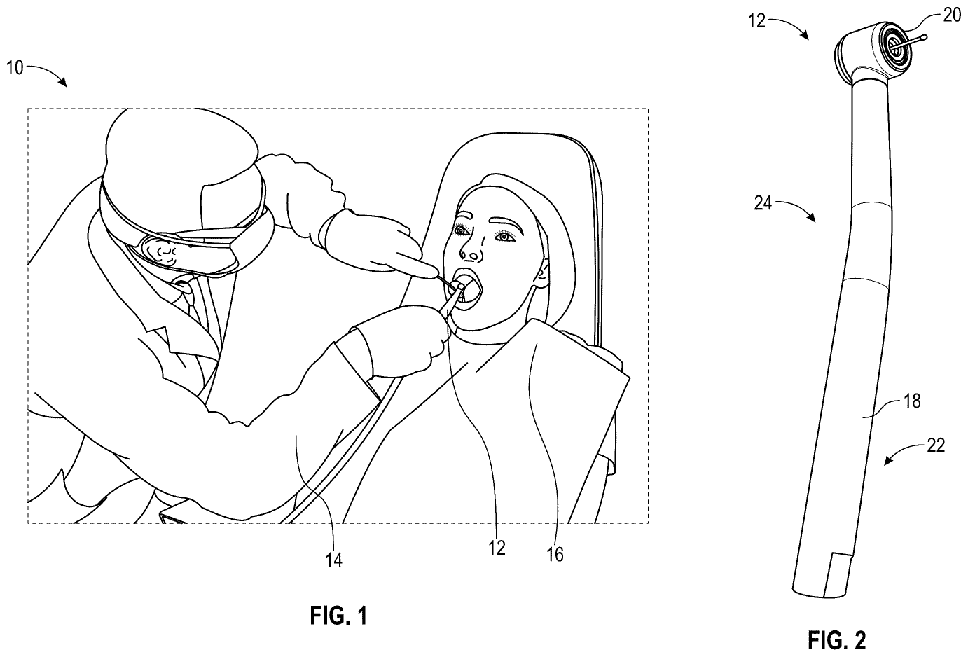

Turning to the Figures, FIG. 1 shows an environment 10 in which a dental drill 12 is being used by a dentist 14 to treat dental issues of a patient 16, in accordance with one embodiment of the present invention. Dental drill 12 indicates a dental handpiece or medical instrument used to perform a variety of dental procedures, including, but not limited to, removing decay, polishing fillings, performing cosmetic dentistry, and altering prostheses. FIG. 2 shows a perspective view of dental drill 12, in accordance with one embodiment of the present invention. Dental drill 12 is made of a metal or any other suitable material. Dental drill 12 includes a body or handle or elongated body 18 and a head or drill head or head portion 20. Body 18 comes in an elongated configuration and helps dentist 14 to hold and operate dental drill 12. In one example, body 18 comes in a tubular (straight) configuration. In another example, body 18 comes in a curved tubular configuration. Dental drill 12 has a first end 22 and a second end 24. First end 22 indicates a front end of dental drill 12. Second end 24 indicates a rear end of dental drill 12.

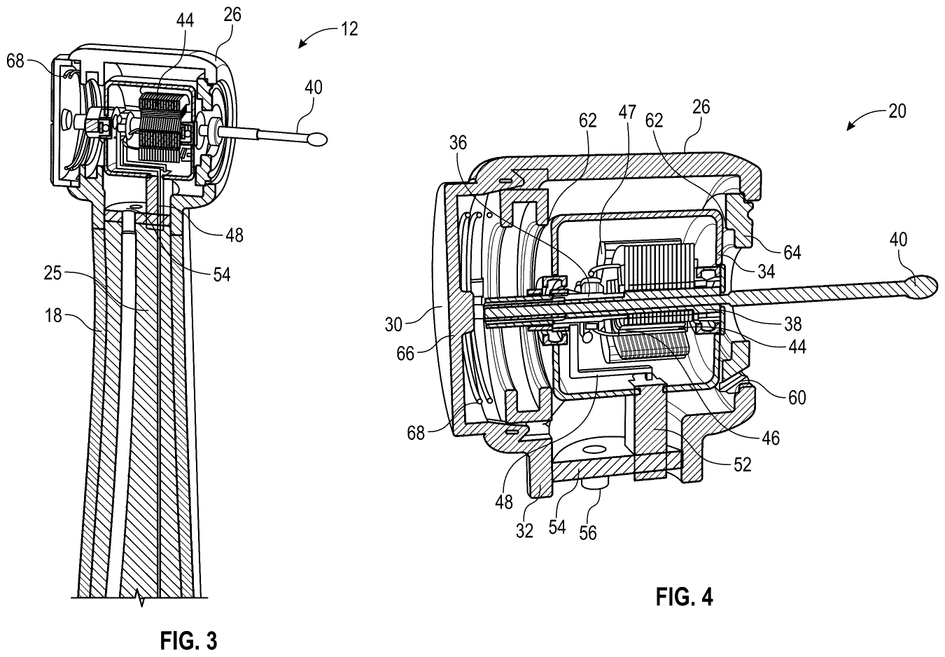

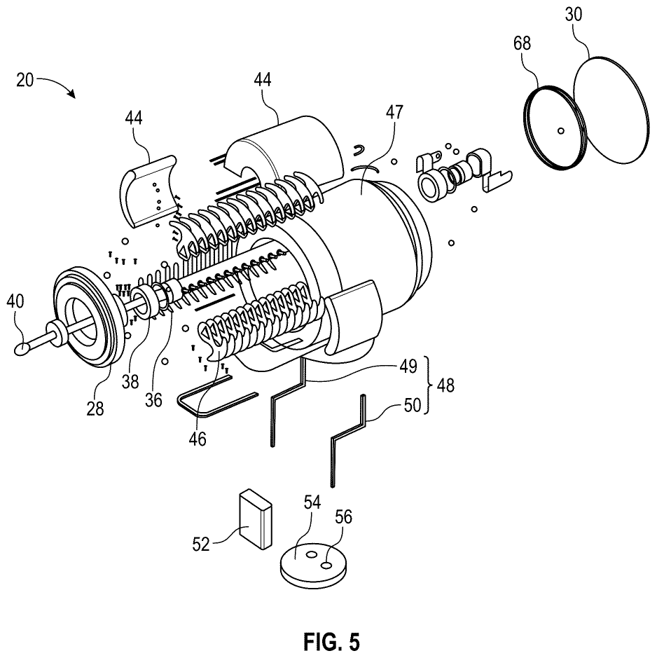

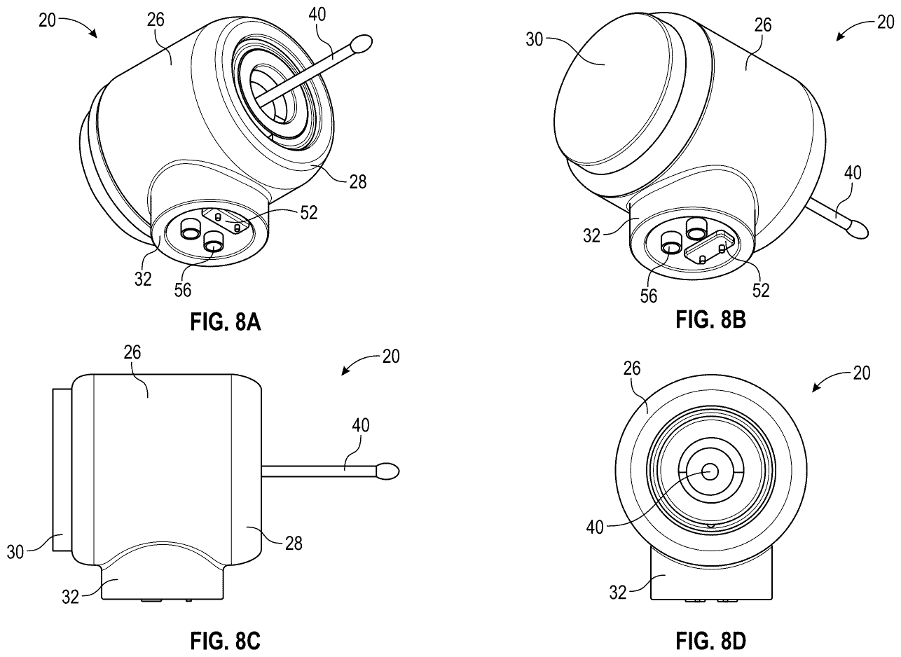

FIG. 3 shows a cross-sectional view of body 18 and head 20. Further, FIGS. 4 and 5 show a cross-sectional view, and an exploded view, respectively of head 20, in accordance with one embodiment of the present invention. Furthermore, FIGS. 8A, 8B, 8C and 8D show a front bottom perspective view, a rear bottom perspective view, a side view and a front view, respectively of head 20, in accordance with one embodiment of the present invention. Body 18 has an interior 25, as shown in FIG. 3. Interior 25 indicates a spacing or hollow portion inside body 18 for receiving various components for operating dental drill 12. Referring to FIGS. 3 and 4, head 20 includes a housing 26. Housing 26 indicates an outer frame in a tubular configuration. Housing 26 includes a first cap or water cap 28 and a second cap 30. Water cap 28 indicates a front cap positioned at first end 22. Further, second cap 30 indicates a rear cap positioned at second end 24. Housing 26 includes a neck or neck portion 32. Neck 32 extends perpendicularly from housing 26 facing body 18. Neck 32 connects to body 18, as shown in at least FIG. 2.

Housing 26 encompasses a casing 34. Casing 34 is made of aluminum or any other suitable material. Casing 34 indicates a tubular housing surrounding motor 47 and magnetic turbine 44. In the present embodiment, the inside of casing 34 acts as a housing unit for electromagnetic direct-current (DC) turbine i.e., magnetic turbine 44. As such, casing 34 protects magnetic turbine 44 from outside debris and/or water damage. In other words, casing 34 acts as a retainer or barrier for magnetic turbine 44 and/or and the other inner components within head 20. Further, casing 34 acts as an attachment for magnetic turbine 44 and can be removed for sterilization. When needed, magnetic turbine 44 is removed or installed in head 20 by holding casing 34. For instance, casing 34 is removed to access magnetic turbine 44.

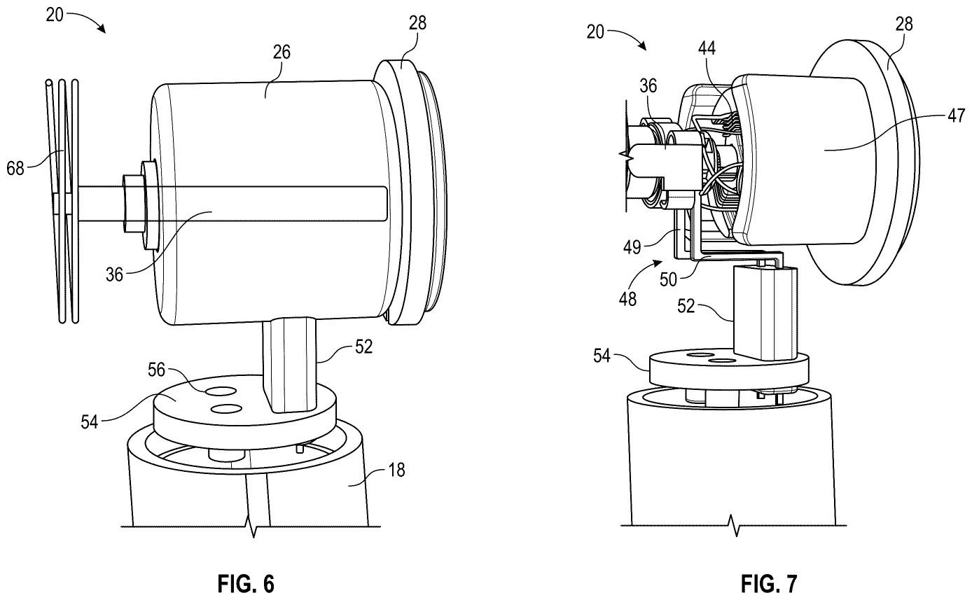

Housing 36 further includes a chuck 36. FIG. 6 shows a side view of chuck 36 inside head 20. Chuck 36 presents a spindle 38. Spindle 38 connects to chuck 36 and receives a bur or drill bit or tool tip 40. Bur 40 is made of steel, stainless steel, tungsten carbide, diamond grit or any other suitable material. Bur 40 is used to cut hard tissues such as tooth or bone in mouth cavity of patient 16. In one example, bur 40 includes a ceramic bur capable of dentin removal and cavity preparation. In another example, bur 40 includes a cylindrical bur capable of removing amalgam restorations. In another example, bur 40 includes a finishing bur designed to add the finishing touches such as shape and finer detail to restorations. Here, spindle 38 holds bur 40 and helps to operate bur 40 at speeds of 180,000-350,000 rotation per minute (rpm).

In accordance with the present invention, housing 26 includes magnetic turbine 44 having a coil or coil wrap 46 housed in a motor (direct current (DC) motor) 47. FIG. 7 shows motor 47 surrounding magnetic turbine 44 having coil 46. In the present embodiment, magnetic turbine 44 includes bearings (not shown). In one example, two bearings made of rubber are used. The bearings allow for great torque and weight control and help to reduce noise during the use of dental drill 12. The bearings sit on spindle 38 i.e., one bearing sits in the front of magnetic turbine 44 and another bearing sits behind magnetic turbine 44. The bearings spin along with bur 40, chuck 36, and spindle 38. In the present embodiment, rubber bearings are preferred over ceramic bearings as the ceramic bearings rust and tear over a period of time. The rubber bearings provide right weight control and torque, and prevent from listening to the sound of a screeching drill. The rubber bearings are easy to sterilize and clean.

Further, magnetic turbine 44 provides one or more coils or coil wraps 46 so that magnetic turbine 44 can have more rotations per minute (RPMs). The magnetic turbine 44 can be powered by solar panels or generators via connectors 48 i.e., wires.

As specified above, casing 36 surrounds motor 47. Casing 36 ensures internal components such as magnetic turbine 44 and coil 46 are protected from water jet 60 when dental drill 12 is in use. Connectors 48 include a first connector 49 and a second connector 50. First connector 49 indicates a positive connector. Second connector 50 indicates a negative connector. Connectors 48 help to connect magnetic turbine 44 to a power supply (not shown).

Connectors 48 draw through a wire insulator 52. Wire insulator 52 enables electricity to flow into and out of dental drill 12. Connectors 48 electrically connect body 18 and magnetic turbine 44. Wire insulator 52 extends from head 20, and helps to connect head 20 and body 18. Further, housing 26 includes a platform 54 having water inlet portion 56. Water inlet portion 56 receives water to be used by water jet 60 to spray while bur 40 is used. Further, housing 26 includes a water cap 28 at first end 22. Water jet 60 sprays water when bur 40 is used. Water cap 28 guides water down on bur 40 while bur 40 is being used. Water cap 28 further assists in the flow of the water-cooling system through dental drill 12 and provides a better view to dentist 14 during the procedure and/or affected enamel. Further, the front end of water cap 28 protects magnetic turbine 44. In one example, water cap 28 includes a hole (not shown) to position water jet 60 in order to spray out the water. Further, water cap 28 prevents water from water jet 60 getting into casing 34. Further, housing 26 includes O-rings 62 and a light ring 64. Light ring 64 indicates a plurality of Light Emitting Diodes (LEDs) placed in a ring-like structure for providing light onto a workspace i.e., mouth/teeth during use.

Further, housing 26 includes a push button mechanism 66 at second end 24. Push button mechanism 66 includes a spring member 68. In one example, push button mechanism 66 is pushed open to access and change internal parts of bur 40 and head 20.

In use, head 20 encompassing magnetic turbine 44 is connected to body 18 via neck 32. In one example, head 20 is attached to body 18 and magnetic turbine 44 is inserted into head 20. Further, head 20 is detached from body 18 for sterilization and cleaning purposes. In one alternate embodiment, body 18 includes a lock mechanism (not shown). The lock mechanism helps to lock head 20 to body 18. Further, bur 40 inserts into chuck 36 while spindle 38 goes over chuck 36. Chuck 36, spindle 38 and bur 40 spin when rotor/magnetic turbine 44 is on. In order to perform a dental procedure, say removal of decay, dentist 14 operates dental drill 12 by supplying power. Here, connectors 48 connect to coil wraps 46 and enable the rotation of the magnetic field in magnetic turbine 44. The magnetic field causes spindle 38 to rotate at a high speed say at speeds of 180,000-350,000 rotation per minute (rpm). This causes bur 40 to rotate at 180,000-350,000 rpm. Magnetic turbine 44 having rubber bearings allow for greater torque and help to produce less noise. As a result, the noise produced during the operation of dental drill 12 is less.

When needed, dentist 14 presses push button mechanism 66 in order to disengage chuck 36 and/or insert/remove bur 40. In the present embodiment, the presence of magnetic turbine 44 eliminates the use of air driven dental drills as in the prior art. Further, magnetic turbine 44 eliminates the use of an impeller and ceramic ball bearings, which are the main parts that create the screeching sound of prior art dental drills.

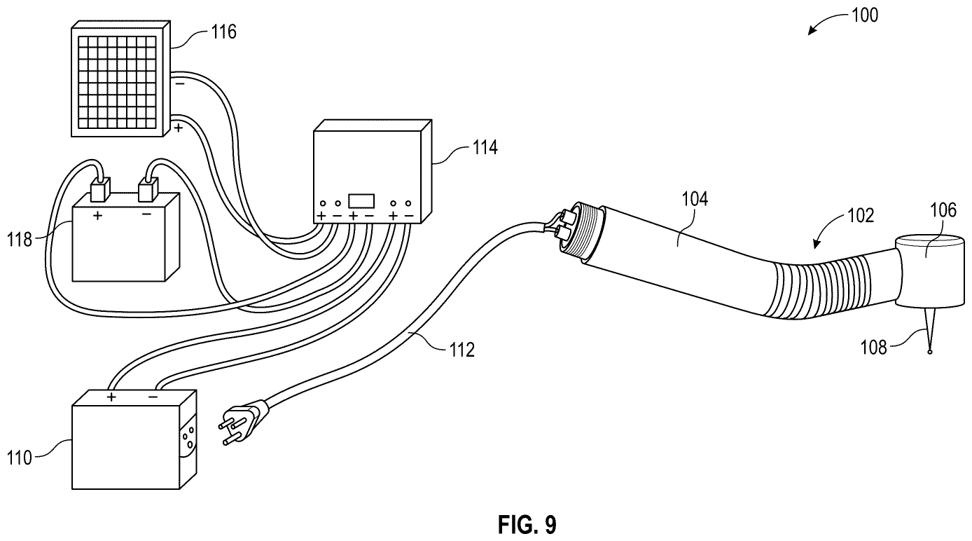

Referring to FIG. 9, an environment 100 of a dental drill 102 used with solar panels 116 is shown, in accordance with one embodiment of the present invention. Dental drill 102 includes all components and operates similar to dental drill 12 as presented above. Dental drill 102 includes body 104, head 106 and bur 108. Dental drill 102 is powered by an inverter 110 by a cable 112. Inverter 110 connects to a controller 114, connected to a battery 118. Battery 118 gets charged using the energy received from solar panels 116. In one example, dental drill 102 operates directly from the power received from solar panels 118. In another example, dental drill 102 operates from the power stored in battery 118. In one embodiment, inverter 110 and/or solar panels 118 include a plurality of capacitors (not shown). The capacitors hold the electric charge and supply the electric charge to operate dental drill 102 when needed.

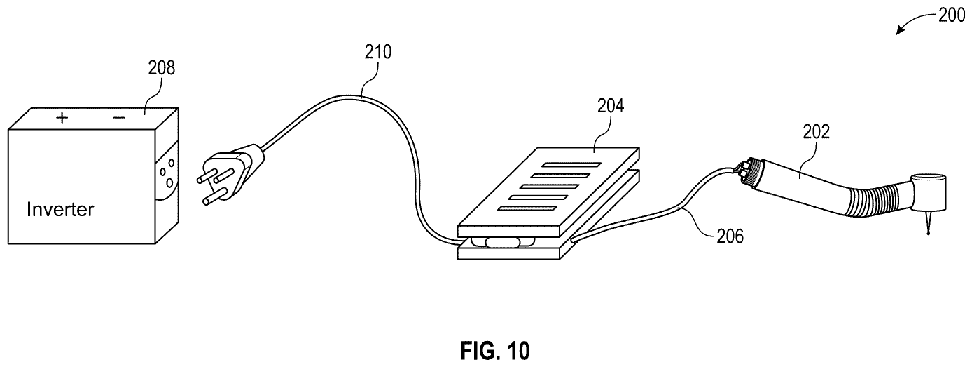

Referring to FIG. 10, an environment 200 of a dental drill 202 operated using a foot pedal 204 is shown, in accordance with another embodiment of the present invention. Dental drill 202 includes all components and operates similar to dental drill 12 as presented above. Foot pedal 204 includes a mechanical or electric foot pedal depending on the need. In one embodiment, foot pedal 204 operatively connects to dental drill 202 via a first cable 206. Further, foot pedal 204 connects to a power source 208 via a second cable 210. In one example, power source 208 includes an inverter or a solar panel (not shown) as shown in FIG. 9. As can be seen in FIG. 10, foot pedal 204 electrically connects to power source 208 and dental drill 202 via cables 206, 210. In order to operate dental drill 202, foot pedal 204 receives required amount of power i.e., electric charge (amps/volts/watts) from power source 208. Further, foot pedal 204 sends the electric charge to dental drill 202. In one example, dentist 14 operates foot pedal 204 with his/her legs to control the speed of dental drill 202 i.e., rotations per minute of a bur (similar to bur 40 shown in FIG. 4). In other words, the electric current flows from power source 208 into dental drill 202 via foot pedal 204 to operate the dental drill 202.

Although the above embodiment illustrates dental drill 202 being operated using foot pedal 204, a person skilled in the art understands that it is possible to replace foot pedal 204 with a hand-held device or any other intermediary device (not shown) without departing from the scope of the present invention.

The embodiments provide for several advantages over the prior art. For example, the presently disclosed dental drill presents an improved stealthy dental tool that operates and completes the tasks for the dentist. Further, the dental drill eliminates use of air compression from dental handpieces. Further, the dental drill eliminates high pitch frequency and heat along with ensuring the dental drill is lightweight, durable, and has great torque. The dental drill requires a positive and negative charge that carries enough watts to power high RPMs. The dental drill operates using solar panels or a generator or battery. Further, the water jet and water cap prevent the bur and the entire dental drill from overheating. The device can also be sterilized in accordance with ADA standards.

The dental drill helps to maintain oral health. The dental drill produces less or minimal noise. As a result, the patients feel relaxed and comfortable during procedures physically/mentally. Further, the dental drill is lightweight and easy to grasp and prevents it from continually being dropped and possibly damaged. The improved dental drill design entices patients to keep and maintain their dental checkups and allow everyone to be more relaxed during dental examinations, cleanings, and various other procedures and may help to reduce the ear-piercing sound of the dental drill.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

What is claimed is:

1. A dental drill having a low noise level, the dental drill comprising:
an elongated body;
a head portion connected at one end of the elongated body;
a motor positioned in the head portion, wherein the motor rotates about an axis;
a magnetic turbine within the motor;
a bur inserted into a chuck;
a spindle connected to the chuck; and
connectors,
wherein the connectors electrically connect to the magnetic turbine and provide a magnetic field to the magnetic turbine causing the chuck, the spindle and the bur to rotate.

2. The dental drill of claim 1, wherein the connectors include a positive connector and a negative connector to power the magnetic field to the magnetic turbine.

3. The dental drill of claim 1, wherein the magnetic turbine comprises coil wraps, and wherein the coil wraps connect to the connectors for enabling a rotation of the magnetic field in the magnetic turbine.

4. The dental drill of claim 1, wherein the motor comprises a casing, and wherein the casing protects the magnetic turbine from debris and water damage.

5. The dental drill of claim 4, wherein the casing is removed to access the magnetic turbine.

6. The dental drill of claim 1, wherein the connectors comprise a wire insulator, and wherein the wire insulator facilitates in flowing of electricity into and out of the magnetic turbine.

7. The dental drill of claim 1, wherein the magnetic turbine comprises bearings.

8. The dental drill of claim 7, wherein the bearings are made of rubber material.

9. The dental drill of claim 1, wherein the head portion comprises a water jet, and wherein the water jet sprays water when the bur is rotated.

10. The dental drill of claim 9, wherein the head portion comprises a water cap, wherein the water cap helps to position the water jet and prevents water from getting into the magnetic turbine.

11. The dental drill of claim 1, further comprises a push button mechanism connected to the bur, wherein the push button mechanism is operated to disengage the chuck, and to insert or remove the bur.

12. A method of providing a dental drill having a low noise level, the method comprising the steps of:
providing an elongated body;
providing a head portion, the head portion connecting at one end of the elongated body;
providing a motor in the head portion, the motor configured for rotating about an axis;
providing a magnetic turbine within the motor;
providing a bur inserted into a chuck;
providing a spindle connected to the chuck;
providing connectors;
electrically connecting the connectors to the magnetic turbine; and,
providing a magnetic field to the magnetic turbine causing the chuck, the spindle and the bur to rotate.

13. The method of claim 12, further comprising providing a positive connector and a negative connector in the connectors to provide the magnetic field to the magnetic turbine.

14. The method of claim 12, further comprising providing coil wraps in the magnetic turbine.

15. The method of claim 14, further comprising connecting the coil wraps to the connectors for enabling a rotation of the magnetic field in the magnetic turbine.

16. The method of claim 12, further comprising providing a casing around the motor for protecting the magnetic turbine from debris and water damage.

17. The method of claim 16, further comprising removing the casing to access the magnetic turbine.

18. The method of claim 12, further comprising providing a wire insulator around the connectors for facilitating in flowing of electricity into and out of the magnetic turbine.

19. The method of claim 12, further comprising providing in the magnetic turbine.

20. The method of claim 12, further comprising:
providing a water jet in the head, the water jet configured for spraying water when the bur is rotated; and
providing a water cap positioned at the head portion, the water cap preventing water from getting into the magnetic turbine.
